(19) United States
(12) Patent Application Publication
(10) Pub. No.: US 2018/0351597 A1
(43) Pub. Date: Dec. 6, 2018

(54) PROTECTIVE CASE FOR ELECTRONIC DEVICE AND MOBILE DEVICE FOR WIFI ACCESS

(71) Applicant: BEIJING XIAOMI MOBILE SOFTWARE CO., LTD., Beijing (CN)

(72) Inventors: Zheng XING, Beijing (CN); Lei ZHANG, Beijing (CN); Zhenhua LIU, Beijing (CN)

(73) Assignee: BEIJING XIAOMI MOBILE SOFTWARE CO., LTD., Beijing (CN)

(21) Appl. No.: 15/953,379

(22) Filed: Apr. 13, 2018

(30) Foreign Application Priority Data
May 31, 2017 (CN) 201710399054.3

(51) Int. Cl. H04B 1/3888; H04M 1/02

(52) U.S. Cl. CPC H04B 1/3888; H04W 84/12; H04M 1/0202

(57) ABSTRACT

The present disclosure relates to a protective case for an electronic device and a mobile device for WIFI access. A WIFI module is built-in a protective case for an electronic device, and the WIFI module may provide a WIFI signal for an electronic device assembled in the protective case for the electronic device. In addition, the mobile device for WIFI access is configured to have an assembling component for assembling with and engaging with an electronic device. Therefore, the mobile device for WIFI access may provide WIFI for an electronic device, and can also be assembled with the electronic device, and thus it is easy to carry.

### CROSS-REFERENCE TO RELATED APPLICATIONS

This application is based on and claims priority to Chinese Patent Application No. 201710399054.3 filed on May 31, 2017, which is incorporated herein by reference in its entirety.

### TECHNICAL FIELD

The present disclosure relates to the field of electronic technology, and more particularly to a protective case for an electronic device and a mobile device for WIFI access.

### BACKGROUND ART

WIFI is a technology for wireless local area networking with devices based on the IEEE 802.11 standards. When using an electronic device that needs to connect to a network such as a mobile phone at an unusual place, since there is no free WIFI network, and mobile data traffic and mobile hotspot tariffs are high, a user will choose to carry a mobile device for WIFI access alone to provide WIFI network for an electronic device such as a mobile phone, etc.

In the related art, a mobile device for WIFI access usually includes a structure such as a WIFI module and a built-in power supply, etc., which leads to its large size and inconvenience of carrying.

### SUMMARY

In order to overcome the problems in the related art, the present disclosure provides a protective case for an electronic device and a mobile device for WIFI access.

According to a first aspect of the present disclosure, there is provided a protective case for an electronic device. The protective case for the electronic device may be assembled with the electronic device to protect the electronic device; and a WIFI module is built-in the protective case for the electronic device.

According to a second aspect of the present disclosure, there is provided a mobile device for WIFI access, which includes an assembling component configured to engage with at least a part of an electronic device to enable the assembling of the electronic device with the mobile device for WIFI access; and a WIFI module configured to transmit a WIFI signal.

According to a third aspect of the disclosure, a protective case may include a housing configured to accommodate and protect the electronic device. The protective case may further include a built-in WIFI module in the housing for the electronic device to connect with a wireless network.

It is to be understood that both the forgoing general description and the following detailed description are exemplary and illustrative only, and are not restrictive of the present disclosure.

### BRIEF DESCRIPTION OF THE DRAWINGS

The drawings are incorporated in, and formed a part of, the specification to show embodiments in conformity with the disclosure, and are for the purpose of illustrating the principles of the disclosure along with the specification.

FIG. 1 is a diagram of an application scenario of a mobile device for WIFI access in the related art;

FIG. 2 s a diagram of an application scenario of another mobile device for WIFI access in the related art;

FIG. 3 is a schematic structural diagram of a mobile device for WIFI access in an aspect of the present disclosure;

FIG. 4 is a schematic structural diagram of a mobile device for WIFI access in another aspect of the present disclosure;

FIG. 5 is a schematic structural diagram of a mobile device for WIFI access in yet another aspect of the present disclosure;

FIG. 6 is a schematic structural diagram of a mobile device for WIFI access in a further aspect of the present disclosure;

FIG. 7 is a schematic structural diagram of a concave portion in an aspect of the present disclosure;

FIG. 8 is a schematic structural diagram of a concave portion in another aspect of the present disclosure;

FIG. 9 is a schematic structural diagram of a protective case for an electronic device in an aspect of the present disclosure;

FIG. 10A is a user interface diagram of a mobile phone when a protective case for the mobile phone is used with the mobile phone cooperatively in an aspect of the present disclosure;

FIG. 10B is a user interface diagram of a mobile phone when a protective case for the mobile phone is used with the mobile phone cooperatively in another aspect of the present disclosure;

FIG. 10C is a user interface diagram of a mobile phone when a protective case for the mobile phone is used with the mobile phone cooperatively in yet another aspect of the present disclosure;

FIG. 10D is a user interface diagram of a mobile phone when a protective case for the mobile phone is used with the mobile phone cooperatively in a further aspect of the present disclosure.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the disclosure. Instead, they are merely examples of apparatuses and methods consistent with aspects related to the disclosure as recited in the appended claims.

The present disclosure is described by taking a mobile device for WIFI access applied to a mobile phone as an example, the structural improvements involved therein are also applicable to an electronic device connected to a network through WIFI, such as a tablet computer and a smart watch, etc.

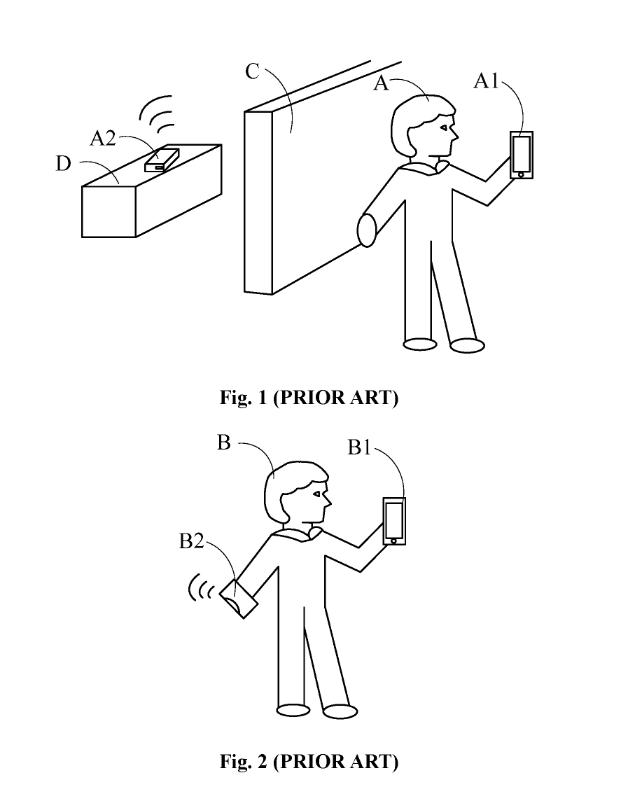

Since a mobile device for WIFI access A2 generally has a predetermined coverage area, the WIFI network can be used when the mobile phone A1 is within the predetermined area, and the farther the distance from the mobile device for WIFI access A2, the worse a WIFI signal received by the mobile phone A1 is. When the mobile phone A1 exceeds the above predetermined area, the WIFI network is not able to be used. In addition, the spread of the WIFI signal is also limited by an obstacle that needs to be crossed. When the WIFI signal strength is insufficient to penetrate the obstacle, the mobile phone A1 at the other end of the obstacle is not able to use the WIFI network. FIG. 1 is a diagram of an application scenario of a mobile device for WIFI access in the related art. As shown in FIG. 1, a user A places the mobile device for WIFI access A2 separately on a desktop D, and holds the mobile phone A1 in his hand. When the user A walks in the room, the distance between the user A and the desktop D is suddenly far and near, causing the signal received by the mobile phone A1 is unstable due to the distance and obstacles such as a wall C. FIG. 2 is a diagram of an application scenario of another mobile device for WIFI access in the related art. As shown in FIG. 2, in order to prevent the WIFI signal received by the mobile phone B1 from being unstable, a user B holds a mobile device for WIFI access B2 independent of a mobile phone B1 and the mobile phone B1 in the hands together, causing a problem regarding inconvenience of carrying.

In order to solve the above problems, the present disclosure improves the structure of the mobile device for WIFI access A2 or B2, which will be specifically described as follows with reference to embodiments.

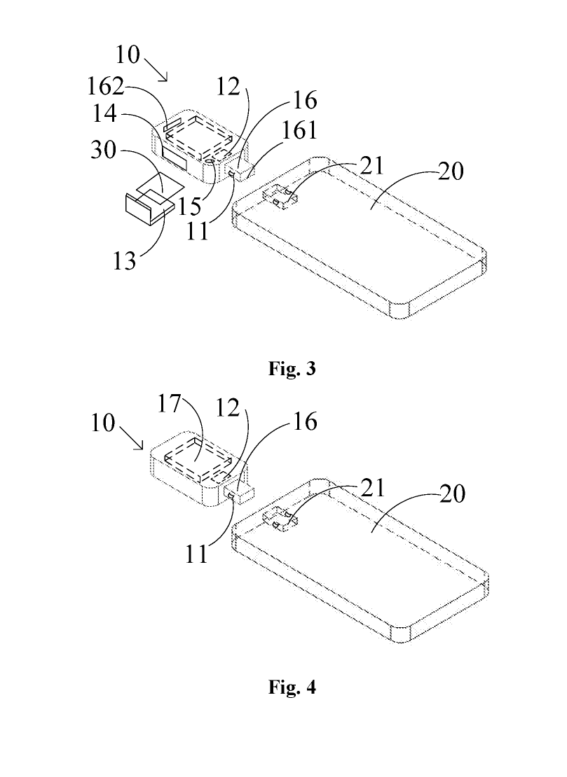

FIG. 3 is a schematic structural diagram of a mobile device for WIFI access in an aspect of the present disclosure. The mobile device for WIFI access 10 as shown in FIG. 3 may include an assembling component 11 and a WIFI module 12. The WIFI module 12 may include one or more hardware circuitries such as transceiver with integrated RF power amplifier and at least one microcontroller in communication with the one or more transceiver. For example, the WIFI module may be a self-contained system on chip (SOC) with integrated TCP/IP protocol stack that can give any microcontroller access to the WIFI network. The assembling component 11 may engage with at least a part of a mobile phone 20 to enable the assembling and engaging of the mobile phone 20 with the mobile device for WIFI access 10. The WIFI module 12 may be associated with the mobile phone 20, and provide a WIFI signal to the mobile phone 20 so that the mobile phone 20 may access a wireless network provided by the WIFI module 12. The above-mentioned mobile device for WIFI access 10 can be assembled on the mobile phone 20, so it is easy to carry.

In one or more embodiments, the mobile device for WIFI access 10 may further include a card tray 13 for installing a network access card 30 and an accommodation slot 14 with a card holder. In the case that the card tray 13 is inserted into the accommodation slot 14 and engaged with the card holder, the network access card 30 is connected to the WIFI module 12. Alternatively, the mobile device for WIFI access 10 may also use a built-in network access card 30 or a network access module embedded in the WIFI module 12, which is not limited in the present disclosure. In addition, the mobile device for WIFI access 10 may further include an indicator light 15 for indicating a connection and usage state of the mobile phone 20 and the WIFI module 12.

In order to solve the power supply problem of the WIFI module 12, the mobile device for WIFI access 10 may further include a power jack 16. The power jack 16 may include a first end 161 and a second end 162. When the mobile phone 20 is assembled with the mobile device for WIFI access 10, the first end 161 of the power jack 16 is connected to a power interface 21 of the mobile phone 20 so as to power the WIFI module 12 through a battery of the mobile phone 20. In addition, the second end 162 of the power jack 16 may be used to connect to an external power supply, so as to charge the mobile phone 20 if necessary. Of course, the mobile device for WIFI access 10 may also use a built-in power supply 17 shown in FIG. 4 to power the WIFI module 12. Alternatively, the mobile device for WIFI access 10 may include both the power jack 16 and the built-in power supply 17, so that the WIFI module 12 can be powered by using the power jack when the power of the mobile phone 20 is sufficient, while the built-in power supply 17 may be used to power the WIFI module 12 when the power of the mobile phone 20 is insufficient or in other cases.

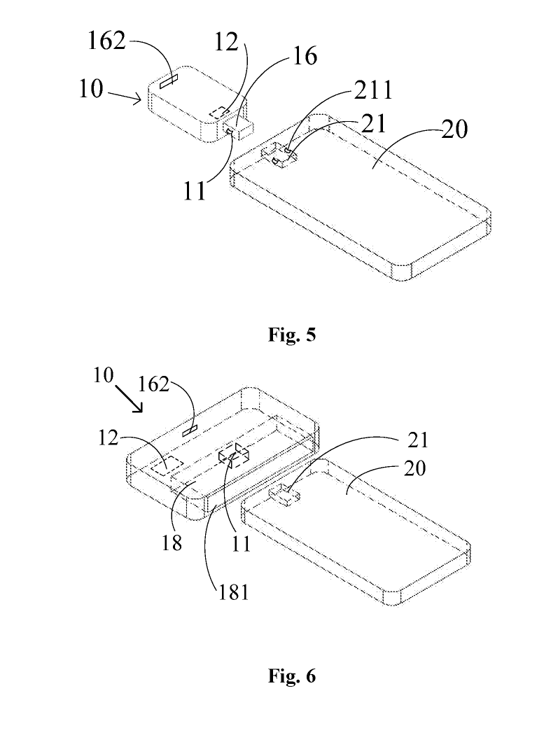

In one or more embodiment shown in FIG. 5, the mobile device for WIFI access 10 may include an assembling component 11, a WIFI module 12, and a power jack 16. The assembling component 11 may also be disposed on the power jack 16 of the mobile device for WIFI access 10 as shown in FIG. 5, and at the same time, a clamping component 211 is disposed on the power interface 21 of the mobile phone 20, and the assembling component 11 is engaged with the clamping component 211 to enable the mobile device for WIFI access 10 to be assembled to the mobile phone 20. The arrangement of the above structure simplifies the overall structure of the mobile device for WIFI access 10, and the assembling of the mobile phone 20 with the mobile device for WIFI access 10 is completed while the power jack 16 engages with the power interface 21 of the mobile phone 20, therefore the operation is simple.

The mobile device for WIFI access 10 shown in FIG. 6 may include an assembling component 11 and a WIFI module 12. The assembling component 11 may include a concave portion 18 disposed on the mobile device for WIFI access 10. The concave portion 18 may be a partially enclosed housing with an opening 181. One end of the mobile phone 20 near the power interface 21 is inserted into the partially enclosed housing from the opening 181, and the partially enclosed housing matches with the edge of the mobile phone 20. A material with a relatively large friction may be selected for an inner wall of the partially enclosed housing to prevent the mobile device for WIFI access 10 from falling off the mobile phone 20. Since the area of the mobile phone 20 to be wrapped by the partially enclosed housing is small, the heat dissipation of the mobile phone 20 will not be affected. It should be noted that other assembly manners may also be selected to enable the accommodating cavity of the mobile device for WIFI access 10 to stably engage with the mobile phone 20, which is not limited in the present disclosure.

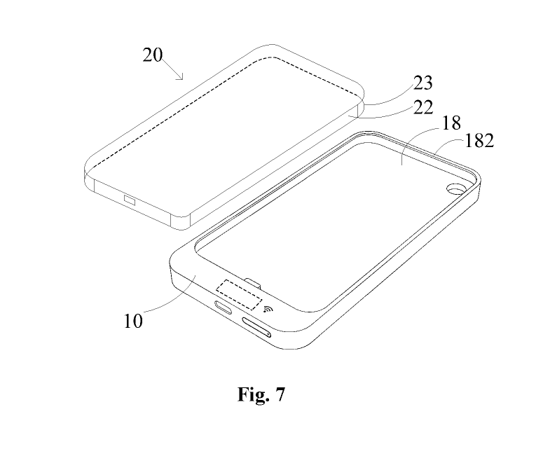

In one or more embodiments, the concave portion 18 may also be a groove with a bottom as shown in FIG. 7. Both a sidewall 22 and a bottom surface 23 of the mobile phone 20 may be accommodated in the groove with a bottom described above, thereby protecting both the sidewall 22 and the bottom surface 23 of the mobile phone 20 from being scratched and collided, which has a better protection effect. An inwardly bended rim 182 may be provided for the groove, and when the mobile phone 20 is positioned within the groove with a bottom, the rim 182 cooperates with the bottom of the groove with the bottom to fix the mobile phone 20 within the groove with a bottom, to prevent the mobile phone 20 from falling off.

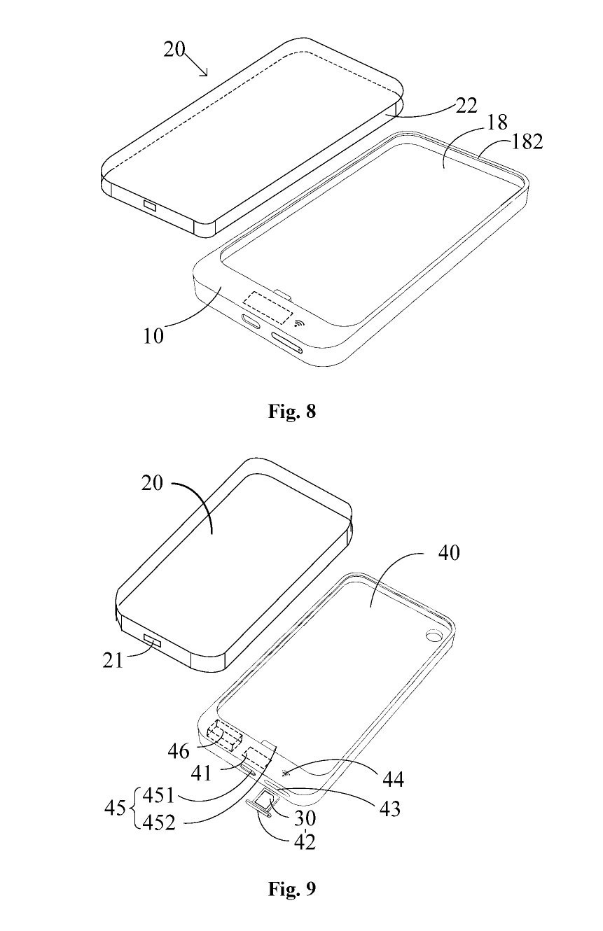

In order to take into account the heat dissipation of the mobile phone 20, the concave portion 18 may also be a groove without a bottom as shown in FIG. 8. The groove without a bottom is sleeved on the sidewall 22 of the mobile phone 20, so as to reduce the area of the mobile phone 20 to be wrapped and ensure a better assembling effect.

In order to improve the practicability of the mobile device for WIFI access, the present disclosure further provides a protective case for an electronic device. A protective case for a mobile phone is taken as an example for description. The structural improvements involved therein are also applicable to an electronic device connected to a network through WIFI, such as a tablet computer and a smart watch, etc.

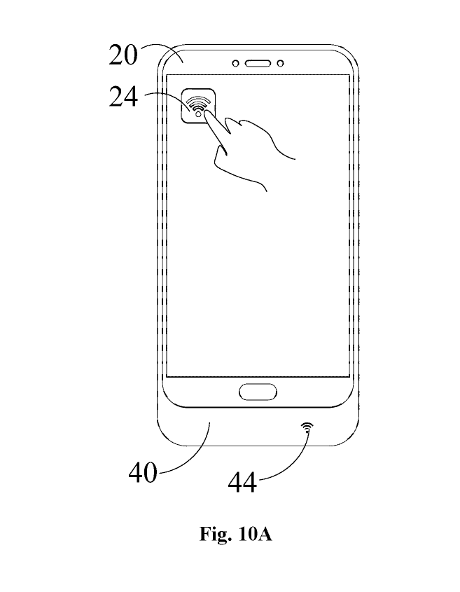

The protective case 40 as shown in FIG. 9 may be assembled with the mobile phone 20 to prevent the mobile phone 20 from being damaged by scratches and impacts. The protective case 40 has a built-in WIFI module 41. The WIFI module 41 may provide the mobile phone 20 with a WIFI signal. Therefore, there is no need to configure a separate mobile device for WIFI access for the mobile phone 20, and the WIFI network can be used as long as the protective case 40 is sleeved on the mobile phone 20.

In one or more embodiments, the protective case 40 may further include a card tray 42 for installing a network access card 30 and an accommodation slot 43 with a card holder. In the case that the card tray 42 is inserted into the accommodation slot 43 and engaged with the card holder, the network access card 30 is connected to the WIFI module 41. Alternatively, the network access card 30 may also be provided in the protective case 40 or a network access module may also be embedded inside the WIFI module 41, which is not limited in the present disclosure. In addition, the protective case 40 may further include an indicator light 44 for indicating a connection and usage state of the mobile phone 20 and the WIFI module 41.

In order to solve the power supply problem of the WIFI module 41, the protective case 40 may further include a power jack 45. When the mobile phone 20 is assembled with the protective case 40, a first end 451 of the power jack 45 is connected to a power interface 21 of the mobile phone 20 so as to power the WIFI module 41. In addition, a second end 452 of the power jack 45 may be used to connect to an external power supply, so as to charge the mobile phone 20. Of course, the protective case 40 may also use a built-in power supply 46 connected to the WIFI module 41 to power the WIFI module 41. Alternatively, the protective case 40 may include both the power jack 45 and the built-in power supply 46, so that the WIFI module 41 can be powered by using the power jack 45 when the power of the mobile phone 20 is sufficient, while the built-in power supply 46 may be used to power the WIFI module 41 when the power of the mobile phone 20 is insufficient or in other cases.

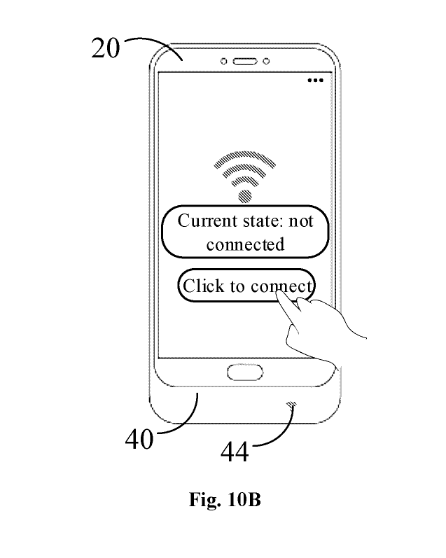

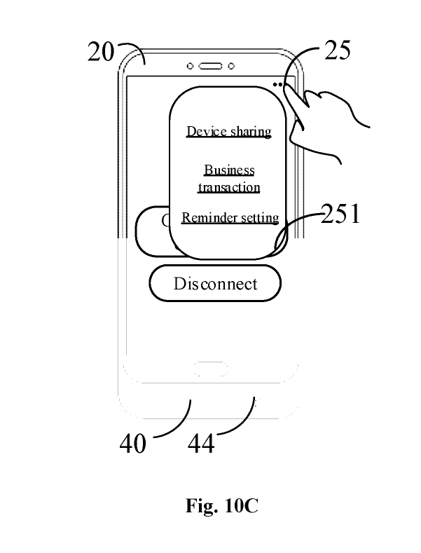

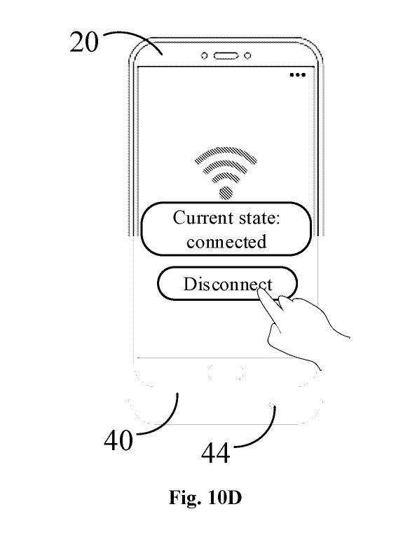

During using the mobile device for WIFI access and the protective case 40 cooperatively with the mobile phone 20, the related functions of the WIFI module 41 and a power switch can also be controlled through an APP of the mobile phone. Specifically, a WIFI APP icon 24 on the screen of the mobile phone as shown in FIG. 10A is clicked to enter a main control interface of the WIFI module 41 as shown in FIG. 10B. The current state is “not connected”, and the indicator light 44 may be displayed in red. After clicking a connection button as shown in FIG. 10B, when the indicator light 44 turns from red to green, the connection is successful, and at this moment, the mobile WIFI network service can be used. A function button 25 may be set on the main control interface of the WIFI module 41, and the function button 25 may be clicked to obtain an extended function menu 251 as shown in FIG. 10C. Specifically, when a friend wants to share the WIFI network with a holder who holds the protective case 40, a device sharing button may be clicked. The system will automatically generate a random password, and the friend can enter the random password to connect to access the network. The random password is time-sensitive, and a user can set an effective time by himself or herself, beyond which the password will be invalid. In addition, under this function, the number of devices being connected may be displayed, therefore whether an unknown device is squatting the network can effectively be viewed. The user may also click on a business button to perform operations related to a business such as real-time package changes and renewal recharge etc. on the WIFI APP. The user may also set some reminder messages through a reminder setting button, such as a reminder regarding arrears, a reminder regarding squatting network, and a reminder regarding a low speed and so on. As shown in FIG. 10D, in a connected state, the indicator light 44 is always-on and is in green. If you want to quit, you may need to click a disconnection button, and after the indicator light 44 turns from green to red, the mobile phone 20 is disconnected from the WIFI network. When the user exits the APP, the indicator 44 is turned off completely and the power of the mobile phone 20 will not be consumed any more.

A person skilled in the art, when considering the descriptions and practicing the present disclosure disclosed here, will easily conceive other implementations of the present disclosure. The present application is intended to cover any variation, use or adaptation of the disclosure, which follow general principle of the disclosure and include general knowledge or customary technical means in the art that are not disclosed herein. The descriptions and embodiments are only regarded to be exemplary, and real scope and spirit of the disclosure are indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A protective case for an electronic device, wherein the protective shell for the electronic device is configured to assemble with the electronic device to protect the electronic device; and a built-in WIFI module in the protective case for the electronic device to connect with a wireless network.

2. The protective case for the electronic device of claim 1, further comprising a built-in power supply for supplying power to the WIFI module.

3. The protective case for the electronic device of claim 1, further comprising a power jack, wherein when the electronic device is assembled with the protective case for the electronic device, a first end of the power jack is connected to a power interface of the electronic device to supply power to the WIFI module by a battery in the electronic device.

4. The protective case for the electronic device of claim 3, wherein a second end of the power jack is connected to an external power supply to charge the electronic device.

5. The protective case for the electronic device of claim 1, further comprising a card tray for installing a network access card and an accommodation slot with a card holder, wherein the card tray is insertable in the accommodation slot and engages with the card holder to enable the network access card to connect to the WIFI module.

6. A mobile device for WIFI access, comprising:
an assembling component configured to engage with at least a part of an electronic device to enable the assembling of the electronic device with the mobile device for WIFI access;
a WIFI module configured to transmit a WIFI signal.

7. The mobile device for WIFI access of claim 6, further comprising a built-in power supply for supplying power to the WIFI module.

8. The mobile device for WIFI access of claim 6, further comprising a power jack, wherein when the electronic device is assembled with the mobile device for WIFI access, a first end of the power jack is connected to a power interface of the electronic device to supply power to the WIFI module by a battery in the electronic device.

9. The mobile device for WIFI access of claim 8, wherein a second end of the power jack is connected to an external power supply to charge the electronic device.

10. The mobile device for WIFI access of claim 8, wherein the assembling component is disposed on the power jack, a clamping component is disposed on the power interface of the electronic device, and the assembling component is engaged with the clamping component to enable the assembling of the mobile device for WIFI access with the electronic device.

11. The mobile device for WIFI access of claim 6, wherein the assembling component comprises a concave portion provided on the mobile device for WIFI access, at least a part of the electronic device is engaged in the concave portion, to enable the assembling of the mobile device for WIFI access with the electronic device.

12. The mobile device for WIFI access of claim 6, further comprising a card tray for installing a network access card and an accommodation slot with a card holder, wherein the card tray is insertable in the accommodation slot and engages with the card holder to enable the network access card to connect to the WIFI module.

13. A protective case, comprising:
a housing configured to accommodate and protect an electronic device; and
a built-in WIFI module in the housing for the electronic device to connect with a wireless network.

14. The protective case of claim 13, further comprising a built-in power supply for supplying power to the WIFI module.

15. The protective case of claim 13, further comprising a power jack, wherein when the electronic device is assembled with the protective case for the electronic device, a first end of the power jack is connected to a power interface of the electronic device to supply power to the WIFI module by a battery in the electronic device.

16. The protective case of claim 15, wherein a second end of the power jack is connected to an external power supply to charge the electronic device.

17. The protective case of claim 13, further comprising a card tray for installing a network access card and an accommodation slot with a card holder, wherein the card tray is insertable in the accommodation slot and engages with the card holder to enable the network access card to connect to the WIFI module.
